(19) United States
(12) Patent Application Publication
(10) Pub. No.: US 2018/0134516 A1
(43) Pub. Date: May 17, 2018

(54) ELEVATOR MONITORING DEVICE WITH GALVANICALLY DECOUPLED SIGNAL TRANSMISSION

(71) Applicant: Inventio AG, Hergiswil (CH)

(72) Inventor: Stefano Carriero, Cham (CH)

(21) Appl. No.: 15/571,610

(22) PCT Filed: May 3, 2016
(86) PCT No.: PCT/EP2016/059805

§ 371 Date: Nov. 3, 2017

(30) Foreign Application Priority Data
May 5, 2015 (EP) 15166314.3

(51) Int. Cl. B66B 5/00

(52) U.S. Cl. CPC B66B 5/0031

(57) ABSTRACT

An elevator monitoring device has a safety chain, an I/O device, and an interface device. It is to be possible for safety signals from the safety chain to be relayed to the I/O device and passed on therefrom, for example, to an external control device. In order to prevent transmission of, for example, dangerously high electrical voltages coming from the safety chain, the interface device is connected between the safety chain and the I/O device. The interface unit contains a signal transmission device that is designed to relay galvanically decoupled signals from inputs to outputs. This makes it possible for safety signals to be read out from the safety chain with the highest possible degree of safety while avoiding electrical overvoltages, and for the signals to be provided to the control device.

### FIELD

The present invention relates to a monitoring device with the aid of which functions and/or safety features of an elevator can be monitored.

### BACKGROUND

Elevators are used, inter alia, to convey people or objects in, principally, a vertical direction. In order to be able to ensure sufficient safety in such conveyance, there is permanent monitoring of, in particular, safety-related functions and features of an elevator system. For this purpose, the elevator system generally has a plurality of safety devices able to control and/or monitor safety-related functions of the elevator system.

The safety devices may have, for example, suitable sensors and/or actuators therefor. For example, safety devices may be provided to and work together with brakes, doors, floors, and/or a control panel of the elevator system. The safety devices may directly or indirectly generate an electrical safety signal that sets forth information about a current status of a monitored safety function. For example, the safety signal may set forth whether a brake is correctly functional or an elevator door has been correctly closed.

Typically in an elevator system, a plurality of such safety devices is connected in series to a so-called safety chain. Each individual one of the safety devices then monitors a component of the elevator system allocated thereto. The series connection of the safety devices makes it possible, with the aid of the safety chain, to discern whether all of the safety devices thereof are signaling, with the aid of the respective safety signals, a correct functioning of all of the safety functions of the elevator system. For example, the safety chain may set forth that all of the brakes of the elevator system are functional, all of the doors have been closed correctly, an elevator car is located at an allowed position within the floor of a building, and a control panel is properly functional. The safety chain may subsequently convey a corresponding signal, for example, to a control device of the elevator system and signal thereto therewith that all of the safety-related components of the elevator system are functioning correctly so that the control device then allows the elevator system to operate and can control same.

In modern elevator systems, there may often be a desire to also be able to monitor functions of the safety devices with the aid of an external control device, as well. For this purpose, it may be desired to be able to relay signals from the safety chain to the external control device.

However, it must then be ensured that an enabled signal transmission from the safety chain to the external control device will not create sources of danger.

There may be, inter alia, a need for an elevator monitoring device with the aid of which safety functions of an elevator system can be monitored safely via an external control device. In particular, it should be possible to securely relay safety signals from a safety chain of an elevator system to an external control device.

### SUMMARY

According to one aspect of the present invention, proposed is an elevator monitoring device having a safety chain, an input/output (I/O) device, and an interface device. The safety chain herein has a plurality of safety devices that are each designed to monitor a safety function of an elevator system and subsequently output an electrical safety signal. The I/O device is designed to read in input signals that each correlate to safety signals of the safety chain, and output corresponding output signals to a preferably external control device. The safety device has inputs for receiving safety signals of the safety chain and outputs for outputting signals as input signals to the I/O device. The interface device is designed to provide safety signals received via the inputs to the outputs, as signals, in a galvanically decoupled manner, via a signal transmission device.

Possible features and advantages of embodiments of the present invention may be considered, inter alia, to be depending on the ideas and findings described hereinbelow.

In light of the need to be able to provide safety signals from a safety chain of an elevator system to an external control device, in order—in particular—to be able to monitor safety functions of the elevator system, there has been a search for possible way to design a corresponding signal transmission in a safe manner, i.e., without danger both for the elevator system and any building components interacting therewith, as well as for users of the control device. In particular, it has been recognized that within the safety chain of an elevator system, signals are often transmitted with high electrical voltages of, for example, up to 250 V, and such high electrical voltages need to be prevented from reaching external apparatuses such as, for example, the control device.

It is therefore proposed, for the purpose of signal transmission between the safety chain and the control device, to provide—between the safety chain and the control device—a specific interface device that can reliably prevent high electrical voltages for being passed on from the safety chain to the control device. The interface device makes use for this purpose of a signal transmission device able to provide signals received via inputs to outputs, as signals in a galvanically decoupled manner.

Galvanic decoupling—sometimes also known as galvanic isolation—is generally understood to mean an absence of electrically conductive connections between conductive objects or electric circuits. Electrical potentials of the objects or electric circuits are thereby separated from one another, i.e., the objects or electric circuits are potential-free from one another. Then, the objects or electric circuits connected to one another over the galvanic isolation are able to exchange electric power or electric signals despite the lack of electrically-conductive connection. Doing so requires coupling members replacing an electrical conductor. Without such coupling members, there would be electrical isolation between the objects or electric circuits in the absence of an electrically conductive connection—i.e., no electrical signals whatsoever could be exchanged.

There are technically various ways to implement a galvanically decoupling signal transmission device or the coupling members to be provided therein. For example, electrical components such as, for example, transformers, capacitors, optocouplers, optical fibers, or relays may be used as coupling members. Signal transmission may, in these cases, then be implemented by means of a magnetic field, displacement of electrical charges, electromagnetic radiation, or a potential-free contact.

For the case of use described herein, of a galvanic decoupling within an interface device in an elevator monitoring device, it generally does not depend on the specific type of technical design of the galvanic decoupling. The desired galvanic decoupling may be performed with the aid of an inductive isolation, capacitive isolation, or another type of isolation. The galvanic decoupling brought about by the signal transmission device should then be implemented in such a manner that signals of high electrical voltage can be reliably prevented from being transmitted from the safety chain to the I/O device and ultimately to the control device.

The I/O device is provided subsequently to the galvanically decoupling interface device on a signal path between the safety chain and ultimately the control device. While the safety chain, with the safety devices thereof, may be regarded as an own technical unit, the I/O device is generally provided as a separate apparatus. In other words, within the safety chain, the safety devices are generally directly connected electrically to one another, in order to exchange or pass on safety signals. The I/O device is provided in order to suitably read in input signals that correlate to these safety signals provided by the safety chain, and relay same in the form of corresponding output signals, for example, to the control device.

As a preferably separate apparatus, the I/O device according to one embodiment has direct electrical connections between I-ports (input ports) and O-ports (output ports), in order to relay the input signals from the I-ports to the O-ports and output same as corresponding output signals. In other words, within the I/O device, there are typically direct electrical connections, i.e., non-galvanically decoupled connections, between the I-ports and the O-ports. One example of an I/O device is an I/O box, such as is sold by the company WAGO Kontakttechnik GmbH & Co. KG, Germany.

While the I/O device may have direct electrical connections both in itself and to the control device, it is important according to one embodiment of the present invention not to provide any direct—i.e., non-galvanically decoupled—electrical connection whatsoever between the safety chain and the I/O device. Due to the absence of such a direct electrical connection, the safety chain is thus isolated from the I/O device with respect to the electrical potential thereof, and no undesirably high electrical voltages can be transmitted directly from the safety chain to the I/O device.

According to one embodiment, both the safety chain and the interface device each have an electrical ground, and the ground of the safety chain is separated from the ground of the interface device. In other words, the interface device should be able to receive safety signals from the safety chain with the inputs, and, for this purpose, preferably is in electrical contact via a direct electrical link to at least one safety device of the safety chain. It should be ensured, however, that the interface device cannot be able to bridge or short-circuit one or more safety devices of the safety chain due to a parallel connection. For this reason, it is proposed to configure a respectively necessary ground of the safety chain on one side and one of the interface device on the other side so as to be electrically isolated from one another.

According to one embodiment, the interface device and optionally also the electrical link thereof to the safety chain on the one hand and the I/O device on the other hand should meet requirements of DN EN 8-1, which applies to elevator systems, as well as optionally also of DIN EN 81-2. Such DIN compliance of the interface device and optionally also the electrical links thereof ensures adequate safety during signal transmission between the safety chain on the one side and the I/O device on the other. The DIN (Deutsche Industrienorm, “Germany Industry Standard”) EN 8-1 and 8-12 govern safety installations for constructing and building elevators, in particular, electrically-operated passenger and freight elevators. Therein, inter alia, safety measures regarding electrical potential isolation in elevator systems are regulated and reliable technical measures are proposed or prescribed.

For example, according to one embodiment, the interface device may be designed to receive, at the inputs thereof, safety signals that have electrical voltages of more than 100 V, preferably more than 200 V, and to output, at the outputs thereof, signals that have electrical voltages of at most 50 V, preferably at most 24 V. When the safety chain is functioning correctly, the input signals may then have currents of only a few mA, for example, less than 5 mA. The signals to be outputted at the outputs of the interface device should preferably have currents of under at most a few hundred mA, for example, at most 100 mA. Appropriate design of the interface device makes it possible to take into account the electrical circumstances inside the safety chain on the one hand and the electrical requirements within the I/O device or control device on the other, and to ensure safe operation of all of the components of the elevator monitoring device.

According to one embodiment, the interface device and the I/O device are provided in separate apparatuses. In other words, the interface device is preferably provided separately, i.e., not integrated into the I/O device. Separation between the interface device and the I/O device may then be both structural and electrical in nature. I.e., the interface device and the I/O device may be provided structurally in separate units and, for example, be accommodated in isolated housings. In terms of electronics, the interface device and the I/O device may have isolated switches or electric circuits that, for example, are separately provided with electrical energy and/or grounded. In practical usage, for example, the I/O device may be provided by another manufacturer than that of the interface device.

Providing a preferably separate interface device for galvanically decoupled signal transmission thus can enable, in an elevator monitoring device, that safety signals can be relayed from a conventionally-designed safety chain of the elevator system in an electrically safe manner—due to being galvanically decoupled via the interface device—to an optionally also conventionally-designed I/O device. The interface device can thus enable safe and, for example, manufacturer-independent signal communication between the safety chain and the I/O device.

According to one embodiment, the interface device has a plurality of lighting devices for indicating status information. The lighting devices are each coupled to one of the inputs of the interface device. The lighting devices may be configured, for example, as LEDs. Due to the lighting devices, for example, a user can, directly at the interface device, obtain information on the current status of the elevator monitoring device or, specifically, the interface device. In particular, the status information may correlate to safety signals received at the respective input of the interface device. A user can thus infer the currently-prevailing safety functions of the elevator system on the basis of the activity of individual lighting devices of the interface device.

It shall be noted that some of the possible features and advantages of the present invention are described herein with reference to different embodiments. A person skilled in the art shall recognize that the features may be combined, adapted, or exchanged as appropriate in order to yield other embodiments of the present invention.

### DESCRIPTION OF THE DRAWINGS

Embodiments of the present invention shall be described hereinbelow, with reference to the accompanying drawings, wherein neither the drawings nor the description are to be interpreted as limiting the present invention.

FIG. 1 illustrates an elevator monitoring device according to one embodiment of the present invention;

FIG. 2 illustrates a schematic circuit diagram of a part of a circuit for an elevator monitoring device according to an advantageous embodiment of the present invention;

FIG. 3 illustrates a schematic circuit diagram of a part of a circuit according to an alternative example; and

FIG. 4 illustrates a schematic circuit diagram of a part of a circuit for an elevator monitoring device according to another embodiment of the present invention.

The drawings are only schematic, and are not true to scale. Like reference signs refer in different drawings to like or analogous features.

### DETAILED DESCRIPTION

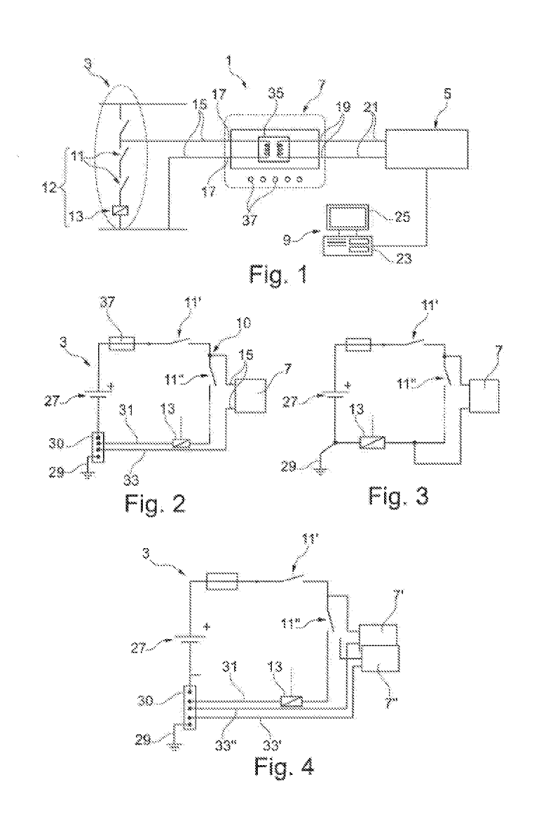

FIG. 1 illustrates an elevator monitoring device 1 according to one embodiment of the present invention. The elevator monitoring device 1 has a safety chain 3, an I/O device 5, and an interface device 7.

The safety chain 3, which may also be called a safety circuit, is configured as an assembly of electrical safety devices 12 that are connected in series. The safety devices 12 may have, for example, a door contact, a latching contact, and/or of contact of a catching or braking device. Each safety device 12 may comprise, for example, an actuator or sensor 13 and an associated switch 11. The actuator or sensor 13 may monitor a safety function of an elevator system and subsequently emit a safety signal that prompts the switch 11 to close or optionally to open.

In the example depicted, a plurality of switches 11 is connected in series, so that the safety chain 3 can only be regarded as closed when all of the switches 11 are closed. Only in this case can the safety chain 3 generate a safety signal that outwardly measurably sets forth that all of the safety devices 12 of the safety chain 3 are functioning correctly and the safety functions monitored thereby are within a normal range. Should one of the switches 11 be interrupted, then the entire safety chain 3 counts as being interrupted, and the elevator system generally cannot continue to be operated. A safety signal generated by the safety device 12 is provided at electrical outputs 15 of the safety chain 3.

Safety signals generated by the safety chain 3 are to be relayed via the I/O device 5 to an external control device 9. The control device 9 may, for example, be a computer 23 equipped with a screen 25 with the aid of which, for example, service personnel can monitor and, in particular, visualize current status information of an elevator system and, in particular, of a safety chain thereof.

In principal, it would be conceivable to relay, directly to inputs 21 of the I/O device 5, the safety signals provided at the electrical outputs 15 of the safety chain 3. This could, however, cause potentially dangerous electrical voltages to be transmitted from the safety chain 3 to the I/O device 5 and therethrough possibly to the control device 9. This could result in damage to a building housing the elevator system, and/or in danger to service personnel using the control device 9.

In order to avoid this, a complementary device in the form of the interface device 7 is provided in a signal path between the safety chain 3 and the I/O device 5.

The interface device 7 is designed to take on, at inputs 17, the safety signals of the safety chain 3 from the outputs 15 thereof and relay signals correlating therewith at outputs 19 to the I/O device 5. The safety signals are not, however, passed on via a direct electrical connection, e.g., in the form of a hard wiring, from the inputs 17 to the outputs 19. Instead, the safety signals are guided to a signal transmission device 35, where they are passed on in a galvanically decoupled manner to the outputs 19.

The signal transmission device 35 is depicted in the depicted example in a simplified manner, as a kind of transformer with which coils pass on the electrical signals inductively—i.e., through generation and transmission of magnetic fields—from the inputs 17 to the outputs 19.

The interface device 7 may also be called a safety circuit signal conditioner (SCSC), and regarded as a universal interface for reading out a status of an elevator safety chain 3. Due to the galvanically decoupled signal transmission within the interface device 7, then, safety signals can be transmitted from the safety chain 3 to the I/O device 5 in a manner that complies with the provisions set forth in DIN EN 81-1 or EN 81-2. Here, for example, both a circuit design and isolations should correspond to the provisions of DIN EN 81-1 or 81-2.

A plurality of LEDs that serve as lighting devices 37 and are able to indicate status information of the interface device 7 or to components of the safety chain 3 that are connected thereto are provided at the interface device 7.

FIG. 2 illustrates a circuit diagram that shows a rough schematic view of how the interface device 7 can be connected relative to components 11, 13 of a safety chain 3 of an elevator monitoring device configured according to the present invention.

The safety chain 3 is here fed by a voltage source 27. The voltage source 27 is generally configured as a direct voltage source. Two switches 11′, 11″ and a sensor 13 or actuator of a safety device 12 are connected in series behind an electrical resistance 39. The safety chain 3 is connected to a ground 29 via a connection 31 at a collector circuit 30, which may also be called a busbar.

The interface device 7 is electrically connected to the series connection of the safety chain 3 at a position 10 between the switches 11′, 11″, so that a safety signal from the safety chain 3 can be transmitted to one of the inputs 15 of the interface device 7. A second of the inputs 15 of the interface device 5 is connected to the ground 29 via another connection 33 at the collector circuit 30.

Here, it may be considered important that the connection of the safety chain 3 to the ground is independent of the connection of the interface device 7 to the ground 29, because the interface device 5 should under no circumstance be able to short-circuit safety-related sensors 13 or actuators of the safety chain 3.

A circuit configuration—as depicted as an alternative in FIG. 3—with which the interface device 7 is connected in parallel to the switch 11″ and is thus connected together therewith via the sensor/actuator 13 to the ground 29 should accordingly be avoided.

FIG. 4 illustrates an alternative circuit configuration for an elevator monitoring device according to the present invention. In this configuration, a plurality of interface devices 7′, 7″ is provided connected in parallel to one another. For a group of channels that are all connected to the same safety chain 3, each interface device 7′, 7″ requires its own independent connection 33′, 33″ to the ground 29.

Finally, it should be noted that terms such as “comprising” and the like do not preclude other elements or steps, and terms such as “a” or “one” do not preclude a plurality. It should also be noted that features that have been described with reference to one of the above embodiments may also be used in combination with other features of other embodiments described above. Reference signs in the claims are not to be interpreted as being limiting.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. An elevator monitoring device comprising:
a safety chain having at least one safety device for monitoring a safety function of an elevator system and outputting an electrical safety signal representing information about the safety function;
an I/O device for reading in an input signal that correlates to the safety signal output from the safety chain, and for outputting a corresponding output signal to a control device;
an interface device having an input for receiving the safety signal output from the safety chain and having an output for outputting the input signal to the I/O device; and
wherein the interface device includes a signal transmission device for passing the safety signal in a galvanically decoupled manner as the input signal.

11. The elevator monitoring device according to claim 10 wherein all electrical connections between the safety chain and the I/O device are galvanically decoupled connections.

12. The elevator monitoring device according to claim 10 wherein the safety chain and the interface device each have an electrical ground connection and the ground connection of the safety chain is separated from the ground connection of the interface device.

13. The elevator monitoring device according to claim 10 wherein the safety signal at the input of the interface device has electrical voltage of more than 100 V or more than 200 V.

14. The elevator monitoring device according to claim 10 wherein the input signal at the output of the interface device has electrical voltage of at most 50 V or at most 24 V.

15. The elevator monitoring device according to claim 10 wherein the I/O device has direct electrical connections between an I-port and an O-port for relaying the input signal from the I-port to the O-put to be outputted as the corresponding output signal.

16. The elevator monitoring device according to claim 10 wherein the interface device and the I/O device are separate apparatuses.

17. The elevator monitoring device according to claim 10 wherein the interface device has a lighting device coupled to the input of the interface device for indicating status information about the safety function.

18. The elevator monitoring device according to claim 17 wherein the status information correlates to the information represented by the safety signal received at the input.

19. An elevator monitoring device comprising:
a safety chain having a plurality of safety devices for monitoring associated safety functions of an elevator system and outputting associated electrical safety signals representing information about the safety functions;
an I/O device for reading in input signals that correlate to the safety signals output from the safety chain, and for outputting corresponding output signals to a control device;
an interface device having inputs for receiving the safety signals output from the safety chain and having outputs for outputting the input signals to the I/O device; and
wherein the interface device includes a signal transmission device for passing the safety signals in a galvanically decoupled manner as the input signals.

20. The elevator monitoring device according to claim 19 wherein all electrical connections between the safety chain and the I/O device are galvanically decoupled connections.

21. The elevator monitoring device according to claim 19 wherein the safety chain and the interface device each have an electrical ground connection and the ground connection of the safety chain is separated from the ground connection of the interface device.

22. The elevator monitoring device according to claim 19 wherein the I/O device has direct electrical connections between I-ports and O-ports for relaying the input signals from the I-ports to the O-puts to be outputted as the corresponding output signals.

23. The elevator monitoring device according to claim 19 wherein the interface device has lighting devices coupled to the inputs of the interface device for indicating status information about the safety functions.

24. The elevator monitoring device according to claim 23 wherein the status information correlates to the information represented by the safety signals received at the inputs.
